(19) United States
(12) Patent Application Publication
(10) Pub. No.: US 2023/0020902 A1
(43) Pub. Date: Jan. 19, 2023

(54) THREE-DIMENSIONAL PRINTING WITH ANNEALED POLYETHER POLYAMIDE COPOLYMER PARTICLES

(71) Applicant: Hewlett-Packard Development Company, L.P., Spring, TX (US)

(72) Inventors: Emre Hiro Discekici, San Diego, CA (US); Carolin Fleischmann, San Diego, CA (US); Jesiska Tandy, San Diego, CA (US); Shannon Reuben Woodruff, San Diego, CA (US); Alay Yemane, San Diego, CA (US)

(73) Assignee: Hewlett-Packard Development Company, L.P., Spring, TX (US)

(21) Appl. No.: 17/786,614

(22) PCT Filed: Jan. 10, 2020
(86) PCT No.: PCT/US2020/013021

§ 371 Date: Jun. 17, 2022

(51) Int. Cl. C09D 11/102; B33Y 10/00; B33Y 70/00; B33Y 30/00; B29C 64/165; C09D 11/037; C09D 11/033

(52) U.S. Cl. CPC C09D 11/102; B33Y 10/00; B33Y 70/00; B33Y 30/00; B29C 64/165; C09D 11/037; C09D 11/033; B29K 2077/00

(57) ABSTRACT

A three-dimensional printing kit can include a fusing agent including water and a radiation absorber and a build material that can include from 95 wt % to 100 wt % of annealed polyether polyamide copolymer particles that can have a D50 particle size from about 2 μm to about 150 μm.

### BACKGROUND

Three-dimensional (3D) printing may be an additive printing process used to make three-dimensional solid parts from a digital model. Three-dimensional printing is often used in rapid product prototyping, mold generation, mold master generation, and short run manufacturing. Some three-dimensional printing techniques can be considered additive processes because they involve the application of successive layers of material. This can be unlike other machining processes, which often rely upon the removal of material to create the final part. Some three-dimensional printing methods can use chemical binders or adhesives to bind build materials together. Other three-dimensional printing methods involve partial sintering, melting, etc. of the build material. For some materials, partial melting may be accomplished using heat-assisted extrusion, and for some other materials curing or fusing may be accomplished using, for example, ultra-violet light or infrared light.

### BRIEF DESCRIPTION OF THE DRAWINGS

FIG. 1 is a schematic illustration of an example three-dimensional printing kit in accordance with the present disclosure;

FIG. 2 is a flow diagram illustrating an example method of three-dimensional printing in accordance with the present disclosure;

FIG. 3 is a schematic illustration of an example three-dimensional printing system in accordance with the present disclosure;

FIG. 4 illustrates an example graph of a differential scanning calorimeter scan of a build material control from an example of the present disclosure;

FIG. 5 illustrates an example graph of a differential scanning calorimeter scan of annealed polyether polyamide copolymer particles from an example of the present disclosure;

FIG. 6 illustrates an example graph of elongation at break data from three-dimensional parts printed using fusing agent and either control build material or build material with annealed polyether polyamide copolymer in accordance with an example of the present disclosure; and

FIG. 7 illustrates an example graph of tensile strength data from three-dimensional parts printed using fusing agent and either control build material or build material with annealed polyether polyamide copolymer in accordance with an example of the present disclosure.

### DETAILED DESCRIPTION

Three-dimensional printing can be an additive process involving the application of successive layers of a build material with a fusing agent printed thereon to bind the successive layers of the build material together. More specifically, a fusing agent including a radiation absorber can be selectively applied to a layer of a build material on a support bed, e.g., a build platform supporting build material, to pattern a selected region of a layer of the build material. The layer of the build material can be indiscriminately exposed to electromagnetic radiation, and due to the presence of the radiation absorber on the printed portions the absorbed light energy at a portion of the layer having the fusing agent printed thereon can be converted to thermal energy, causing that portion to melt or coalesce, while other portions of the build material do not melt or coalesce. This can then be repeated to form the three-dimensional object.

Three-dimensional objects printed from thermoplastic polymer build materials can suffer from mechanical issues. Specifically, three-dimensional objects can be subject to tensile strength and elongation at break issues which can result in brittle failure. The build material presented herein, can reduce or resolve tensile strength and elongation at break issues of three-dimensional objects printed from thermoplastic polymer build materials.

In accordance with this, a three-dimensional printing kit (a “kit”) is presented. The kit can include a fusing agent having water and a radiation absorber and a build material including from about 95 wt % to 100 wt % of annealed polyether polyamide copolymer particles that can have a D50 particle size from about 2 μm to about 150 μm. In another example, the annealed polyether polyamide copolymer can be a block copolymer including a polyether block and a polyamide block. In yet another example, the polyether block can include polypropylene oxide, polyethylene oxide, polytetramethylene oxide, polyethylene oxide-b-propylene oxide, or a combination thereof. In a further example, the polyamide block can include polyamide-6, polyamide-9, polyamide-11, polyamide-12, polyamide-66, polyamide-612, thermoplastic polyamide, or a combination thereof. In one example, the annealed polyether polyamide copolymer particles can exhibit multimodal melting peaks adjacent to one another that are not present prior to annealing. In another example, the build material can be devoid of polymer other than the annealed polyether polyamide copolymer. In yet another example, the kit can further include a detailing agent with a detailing compound. The detailing compound can reduce a temperature of the build material onto which the detailing agent is applied

In another example, a method of three-dimensional printing (a “method”) is presented. The method can include iteratively applying individual build material layers of a build material including from about 95 wt % to 100 wt % of annealed polyether polyamide copolymer particles having a D50 particle size ranging from about 2 μm to about 150 μm; based on a 3D object model, iteratively and selectively dispensing a fusing agent onto individual build material layers, wherein the fusing agent includes water and a radiation absorber; and iteratively exposing a powder bed to energy to selectively fuse the annealed polyether polyamide copolymer particles in contact with the radiation absorber and form a fused polymer matrix at the individual build material layers resulting in a fused three-dimensional object. In one example, the method can further include preliminarily annealing a polyether polyamide copolymer build material at a temperature within 50° C. below a melt peak temperature of a polyether polyamide copolymer for a time period ranging from 15 minutes to 48 hours to form the annealed polyether polyamide copolymer particles. In another example, the annealed polyether polyamide copolymer can be a block copolymer with a polyether block and a polyamide block. The polyether block can include polypropylene oxide, polyethylene oxide, polytetramethylene oxide, polyethylene oxide-b-propylene oxide, or a combination thereof. In a further example, the annealed polyether polyamide copolymer can be a block copolymer with a polyether block and a polyamide block. The polyamide block can include polyamide-6, polyamide-9, polyamide-11, polyamide-12, polyamide-66, polyamide-612, thermoplastic polyamide, or a combination thereof. In yet another example, the fused three-dimensional object can have a tensile strength that can be about 1.2 times to about 4 times greater than a comparative three-dimensional object formed from polyether polyamide copolymer particles that are not annealed but otherwise have the same D50 particle size, molecular weight, and ratio of polyether to polyamide content. In one example, the build material can be devoid of polymer other than the annealed polyether polyamide copolymer.

In a further example, a three-dimensional printing system (a “system”) is presented. The system can include a build material, a fusing agent, a printhead, and a radiant energy source. The build material can include from about 95 wt % to 100 wt % of annealed polyether polyamide copolymer particles having a D50 particle size from about 2 μm to about 150 μm. The fusing agent can include water and a radiation absorber. The printhead can be fluidly coupled to or fluidly coupleable to the fusing agent to selectively and iteratively eject the fusing agent onto successive placed individual layers of the build material. The radiant energy source can be positioned to expose the individual layers of the build material to radiation energy to selectively fuse the annealed polyether polyamide copolymer particles in contact with the radiation absorber to iteratively form a three-dimensional object. In one example, the annealed polyether polyamide copolymer can be a block copolymer with a polyether block and a polyamide block. The polyether block can include polypropylene oxide, polyethylene oxide, polytetramethylene oxide, polyethylene oxide-b-propylene oxide, or a combination thereof, and the polyamide block can include polyamide-6, polyamide-9, polyamide-11, polyamide-12, polyamide-66, polyamide-612, thermoplastic polyamide, or a combination thereof.

When discussing the three-dimensional printing kit, method of three-dimensional printing, and/or the three-dimensional printing system herein, these discussions can be considered applicable to one another whether or not they are explicitly discussed in the context of that example. Thus, for example, when discussing a build material related to a three-dimensional printing kit, such disclosure is also relevant to and directly supported in the context of the method of three-dimensional printing, the three-dimensional printing system, and vice versa.

Terms used herein will have the ordinary meaning in their technical field unless specified otherwise. In some instances, there are terms defined more specifically throughout the specification or included at the end of the present specification, and thus, these terms can have a meaning as described herein.

### Three-Dimensional Printing Kit

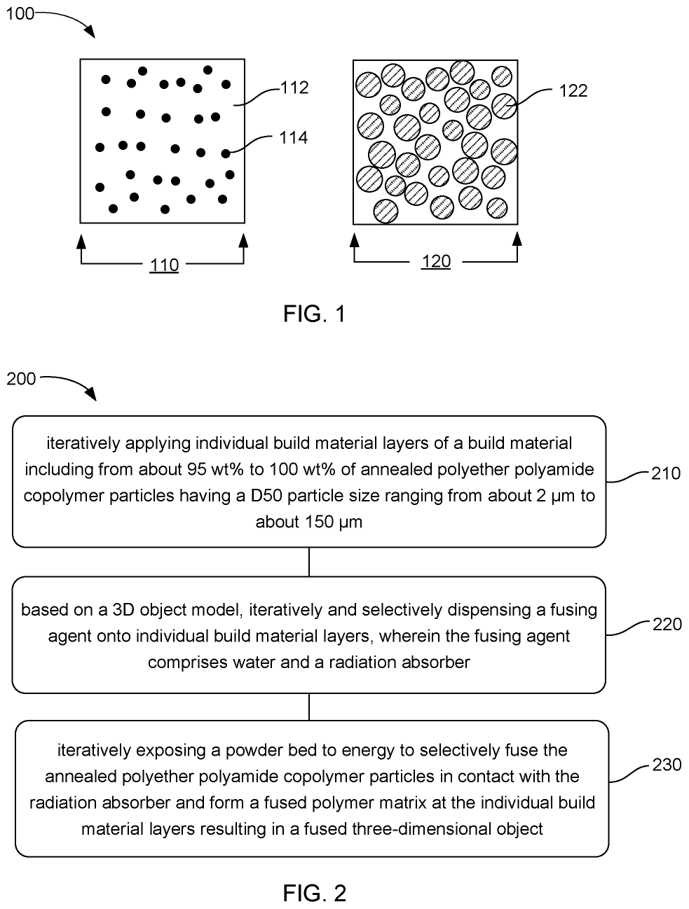

A three-dimensional printing kit 100 is shown by way of example in FIG. 1. The three-dimensional printing kit can include, for example, a fusing agent 110 and a build material 120. The fusing agent can include water 112 (in some instances with additional liquid vehicle components, such as organic co-solvent(s), surfactants, etc.) and a radiation absorber 114. The build material can include from about 95 wt % to 100 wt % of annealed polyether polyamide copolymer particles 122 that can have a D50 particle size from about 2 μm to about 150 μm.

“Annealed” polyether polyamide copolymer can be can be prepared using “controlled heating,” for example, typically followed by subsequent cooling. Controlled heating can include steadily raising a temperature of a build material to a final heating temperature, such as raising a temperature of the build material at from about 2° C. to about 10° C. per minute until a target heating temperature is met. In an example, the annealing can occur within about 50° C. below a melt peak temperature of the polyether polyamide copolymer. As used herein, “melt peak temperature” indicates a temperature at which a polymer melts and transitions from a solid to a liquid. In some examples, the annealing can occur within about 40° C., about 35° C., about 30° C., about 25° C., about 20° C., about 15° C., about 10° C., or about 5° C. below a melt peak temperature for the polyether polyamide copolymer. In a further example, the annealing can occur within a temperature ranging from about 3° C. to about 50° C. or from about 5° C. to about 35° C. below a melt peak temperature of the polyether polyamide copolymer. The annealing can occur for a time period ranging from about 15 minutes to about 48 hours, from about 15 minutes to about 24 hours, from about 30 minutes to about 12 hours, from about 2 hours to about 36 hours, from about 5 hours to about 24 hours, or from about 16 hours to about hours. Annealing can, for example, alter a crystal structure of polyether polyamide copolymer particles without any visible external changes to an exterior surface of the polyether polyamide copolymer particles. In some examples, the annealing can cause a melting peak to separate and form a bimodal or multi-modal melting peak that was not present prior to the annealing.

In additional detail, the three-dimensional printing kit can further include other fluid agents (not shown), such as coloring agents, detailing agents, or the like. A detailing agent, for example, can include a detailing compound, which can be a compound that can reduce the temperature of the build material when applied thereto. In some examples, the detailing agent can be applied around edges of the application area of the fusing agent. This can prevent caking around the edges due to heat from the area where the fusing agent was applied. Alternatively or additionally, detailing agent can be applied in the same area where fusing agent was applied in order to control the temperature and prevent excessively high temperatures when the build material is fused.

In further detail, coloring agent, for example, can be included in some instances and can be used to apply color to the three-dimensionally printed part, or can be added to the fusing agent to provide color to the printed part, or to provide a basis for the user to know where the fusing agent has been applied.

The build material may be packaged or co-packaged with the fusing agent, or can be packaged separately to be brought together by the user. Other fluid agents, e.g., coloring agent, detailing agent, or the like, can likewise be co-packaged with the fusing agent and/or build material in separate containers, and/or can be combined with the fusing agent at the time of printing, e.g., loaded together in a three-dimensional printing system.

### Method of Three-Dimensional Printing

A flow diagram of an example method 200 of three-dimensional (3D) printing is shown in FIG. 2. The method can include iteratively 210 applying individual build material layers of a build material including from about 95 wt % to 100 wt % of annealed polyether polyamide copolymer particles that can have a D50 particle size ranging from about 2 μm to about 150 μm; and based on a 3D object model, iteratively and selectively 220 dispensing a fusing agent onto individual build material layers, where the fusing agent can include water and a radiation absorber. The method can further include iteratively 230 exposing a powder bed to energy to selectively fuse the annealed polyether polyamide copolymer particles in contact with the radiation absorber and form a fused polymer matrix at the individual build material layers resulting in the formation of a three-dimensional object.

In printing in a layer-by-layer manner, the build material can be spread, the fusing agent applied, the layer of the build material can be exposed to energy, and then the build platform can then be dropped a distance of 5 μm to 1 mm, which can correspond to the thickness of a printed layer of the three-dimensional object, so that another layer of the build material can be added again thereon to receive another application of fusing agent, and so forth. During the build, the radiation absorber in the fusing agent can act to convert the energy to thermal energy and promote the transfer of thermal heat to particles of the build material in contact with the fusing agent including the radiation absorber. In an example, the fusing agent can elevate the temperature of the particles of the build material above the melting or softening point of the particles, thereby allowing fusing (e.g., sintering, binding, curing, etc.) of the build material particles and the formation of an individual layer of the three-dimensional object. The method can be repeated until all the individual build material layers have been created and a three-dimensional object is formed. In some examples, the method can further include heating the build material prior to dispensing.

In an example, the method can further include annealing of a polyether polyamide copolymer build material to form the annealed polyether polyamide copolymer particles that can be applied as individual build material layers. Annealing, or “pre-annealing” in some instances, the polyether polyamide copolymer build material can be one way of preparing the build material for use, and can refer to the controlled heating and subsequent cooling of a build material as previously described. This can typically occur in advance of using the build material for building the three-dimensional object, or in some instances, may occur during the build process, e.g., in a separate supply container. Controlled heating can include steadily raising a temperature of a build material to a final heating temperature, such as raising a temperature of the build material at from about 2° C. to about 10° C. per minute until a target heating temperature is met. In an example, the annealing can occur within about 50° C. below a melt peak temperature of the polyether polyamide copolymer. As used herein, “melt peak temperature” indicates a temperature at which a polymer melts and transitions from a solid to a liquid. In some examples, the annealing can occur within about 40° C., about 35° C., about 30° C., about 25° C., about 20° C., about 15° C., about 10° C., or about 5° C. below a melt peak temperature for the polyether polyamide copolymer. In a further example, the annealing can occur within a temperature ranging from about 3° C. to about 50° C. or from about 5° C. to about 35° C. below a melt peak temperature of the polyether polyamide copolymer. The annealing can occur for a time period ranging from about 15 minutes to about 48 hours. In yet other examples, annealing can occur for a time period ranging from about 15 minutes to about 24 hours, from about 30 minutes to about 12 hours, from about 2 hours to about 36 hours, from about 5 hours to about 24 hours, or from about 16 hours to about 30 hours. In an example, annealing can occur at a temperature within 50° C. below a melt peak temperature of the polyether polyamide copolymer for a time period ranging from 15 minutes to 48 hours to form the annealed polyether polyamide copolymer particles. In some examples, annealing can occur in an oven. Annealing can alter a crystal structure of polyether polyamide copolymer particles without any visible external changes to an exterior surface of the polyether polyamide copolymer particles. In some examples, the annealing can cause a melting peak to separate and form a bimodal or multi-modal melting peak that was not present prior to the annealing.

In some examples, the method can result in a three-dimensional object having more tensile strength and better elongation at break than a three-dimensional object formed with a comparable polyether polyamide copolymer that has not been annealed. For example, a three-dimensional object can have a tensile strength that can be about 1.2 times to about 4 times or about 1.5 times to about 3 times greater than a comparative three-dimensional object formed from polyether polyamide copolymer particles that are not annealed but otherwise have the same D50 particle size, molecular weight, and ratio of polyether to polyamide content.

### Three-Dimensional Printing Systems

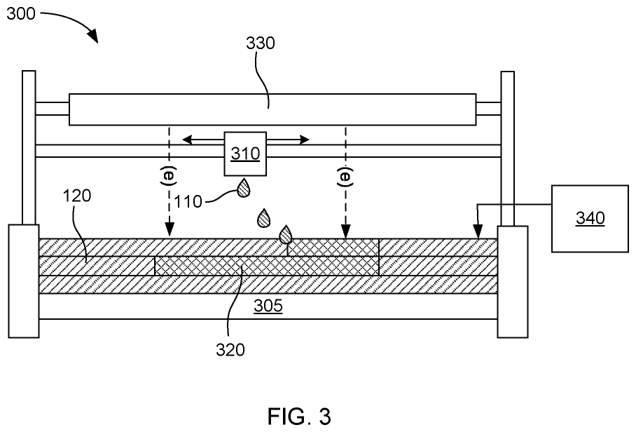

A three-dimensional printing system 300 as illustrated by way of example in FIG. 3, can include a fusing agent 110, a build material 120, a printhead 310, and a radiant energy source 330 to emit electromagnetic energy (e). The build material can include from about 95 wt % to 100 wt % of annealed polyether polyamide copolymer particles having a D50 particle size from about 2 μm to about 150 μm, and in one example, can be applied from a build material supply 340 in layers on a build platform 305 (which in one specific example may be lowered about the distance of a thickness of material to correspond to an applied layer build material, for example), or a previously applied layer of build material. The fusing agent can include water and a radiation absorber. The printhead can be fluidly coupled to or fluidly coupleable to the fusing agent to selectively and iteratively eject the fusing agent onto successively placed individual layers of the build material. The radiant energy source can be positioned to expose the individual layers of the build material to radiation energy to selectively fuse the annealed polyether polyamide copolymer particles in contact with the radiation absorber to iteratively form a three-dimensional object, showed in an initial stage where fused build material layers 320 are being formed.

In further detail, the printhead can be a digital fluid ejector, e.g., thermal or piezo jetting architecture. The printhead, in an example, can be a fusing agent applicator that can be fluidly coupled or coupleable to the fusing agent to iteratively apply the fusing agent to the build material to form individually patterned object layers. The printhead can be any type of apparatus capable of selectively dispensing or applying the fusing agent. For example, the printhead can be a fluid ejector or digital fluid ejector, such as an inkjet printhead, e.g., a piezo-electric printhead, a thermal printhead, a continuous printhead, etc. The printhead could likewise be a sprayer, a dropper, or other similar structure for applying the fusing agent to the build material. Thus, in some examples, the application can be by jetting or ejecting from a digital fluid jet applicator, similar to an inkjet pen.

In an example, the printhead can be located on a carriage track, but could be supported by any of a number of structures. In yet another example, the printhead can include a motor and can be operable to move back and forth over the build material along a carriage when positioned over or adjacent to a powder bed of a build platform.

In an example, the three-dimensional printing system can further include a build platform to support the build material. The build platform can be positioned to permit application of the fusing agent from the printhead onto a layer of the build material. The build platform can be configured to drop in height, thus allowing for successive layers of build material to be applied by a supply and/or spreader. The build material can be layered in the build platform at a thickness that can range from about 5 μm to about 1 mm. In some examples, individual layers can have a relatively uniform thickness. In one example, a thickness of a layer of the build material can range from about 10 μm to about 500 μm, or from about 30 μm to about 200 μm.

Following the selective application of a fusing agent to the build material, the build material can be exposed to energy from the radiation source. The radiation source can be an infrared (IR) or near-infrared light source, such as IR or near-IR curing lamps, IR or near-IR light emitting diodes (LED), or lasers with the desirable IR or near-IR electromagnetic wavelengths, and can emit electromagnetic radiation having a wavelength ranging from about 400 nm to about 1 mm. In one example, the emitted electromagnetic radiation can have a wavelength that can range from about 400 nm to about 2 μm. In some examples, the radiation source can be operatively connected to a lamp/laser driver, an input/output temperature controller, and/or temperature sensors.

### Build Materials

The build material can make up the bulk of the three-dimensional printed object. As mentioned, the build material can include from about 95 wt % to 100 wt % annealed polyether polyamide copolymer particles. In an example, as used herein annealed polyether polyamide copolymer particles can refer to a powder of a copolymer of a polyether and a polyamide that has been heat treated at a temperature within about 50° C. below a melt peak temperature of the copolymer for about 15 minutes to about 48 hours.

In an example, the annealed polyether polyamide copolymer particles can include a block copolymer. The block copolymer can be in an alternating or periodic configuration. In an example, the block copolymer can include alternating blocks, e.g., ABA or BAB block copolymer, or can include two blocks, e.g., AB block copolymer. In one example, the polyether block can include polypropylene oxide, polyethylene oxide, polytetramethylene oxide, polyethylene oxide-b-propylene oxide, or a combination thereof. In another example, the polyamide block can include polyamide-6, polyamide-9, polyamide-11, polyamide-12, polyamide-66, polyamide-612, thermoplastic polyamide, or a combination thereof. In yet another example, the polyether block can include a propylene glycol and the polyamide block can include polyamide-12. In some examples, the annealed polyether polyamide copolymer particles can exhibit multimodal melting peaks adjacent to one another that were not present prior to annealing. In some examples, the build material can exclude polymers other than the annealed polyether polyamide copolymer.

The build material may include similarly sized particles or differently sized particles. The term “size” or “particle size,” as used herein, refers to the diameter of a substantially spherical particle, or the effective diameter of a non-spherical particle, e.g., the diameter of a sphere with the same mass and density as the non-spherical particle as determined by weight. A substantially spherical particle, e.g., spherical or near-spherical, can have a sphericity of >0.84. Thus, any individual particles having a sphericity of <0.84 can be considered non-spherical (irregularly shaped). For example, the particles can have a “D50” particle size from about 2 μm to about 150 μm, from about 20 μm to about 100 μm, or from about 25 μm to about 125 μm. “D50” particle size is defined as the particle size at which about half of the particles are larger than the D50 particle size and about half of the other particles are smaller than the D50 particle size (by weight based on the particle content). Particle size can be collected by laser diffraction, microscope imaging, or other suitable methodology, but in some examples, the particle size (or particle size distribution) can be measured and/or characterized using a MASTERSIZER™ or ZETASIZER™, from Malvern Panalytical (United Kingdom), for example.

The build material can, in some examples, further include flow additives, antioxidants, inorganic filler, or any combination thereof in an amount of about 5 wt % or less. An example flow additives can include fumed silica. An example antioxidants can include hindered phenols. The inorganic filler can include particles such as alumina, silica, fibers, carbon nanotubes, cellulose, or a combination thereof. In some examples, the filler can become embedded in the polymer, forming a composite material.

The build material can be capable of being printed into three-dimensional objects with a resolution of about 20 μm to about 150 μm, about 30 μm to about 100 μm, or about 40 μm to about 80 μm. As used herein, “resolution” refers to the size of the smallest feature that can be formed on a three-dimensional object. The build material can form layers from about 20 μm to about 150 μm thick, allowing the fused layers of the printed object to have roughly the same thickness. This can provide a resolution in the z-axis (i.e., depth) direction of about 20 μm to about 150 μm. The build material can also have a sufficiently small particle size and sufficiently regular particle shape to provide about 2 μm to about 150 μm resolution along the x-axis and y-axis (i.e., the axes parallel to the top surface of the powder bed).

Fusing Agents

In further detail, regarding the fusing agent 110 that may be utilized in the three-dimensional printing kit, method of three-dimensional (3D) printing, or the three-dimensional printing system, as described herein, the fusing agent can include water and a radiation absorber that can absorb radiation energy and convert the radiation energy to heat. Example radiation absorbers can include, for example, a metal dithiolene complex, carbon black, glass fiber, titanium dioxide, clay, mica, talc, barium sulfate, calcium carbonate, near-infrared absorbing dye, near-infrared absorbing pigment, metal nanoparticles, conjugated polymer, or a combination thereof. The radiation absorber can be colored or colorless.

Examples of near-infrared absorbing dyes can include aminium dyes, tetraaryldiamine dyes, cyanine dyes, pthalocyanine dyes, dithiolene dyes, and others. In further examples, the fusing agent can be a near-infrared absorbing conjugated polymer such as poly(3,4-ethylenedioxythiophene)-poly(styrenesulfonate) (PEDOT:PSS), a polythiophene, poly(p-phenylene sulfide), a polyaniline, a poly(pyrrole), a poly(acetylene), poly(p-phenylene vinylene), polyparaphenylene, or combinations thereof. As used herein, “conjugated” refers to alternating double and single bonds between atoms in a molecule. Thus, “conjugated polymer” refers to a polymer that has a backbone with alternating double and single bonds. In many cases, the radiation absorber can have a peak absorption wavelength in the range of about 800 nm to about 1400 nm.

A variety of near-infrared pigments can also be used. Non-limiting examples can include phosphates having a variety of counterions such as copper, zinc, iron, magnesium, calcium, strontium, the like, and combinations thereof. Non-limiting specific examples of phosphates can include M₂P₂O₇, M₄P₂O₉, M₅P₂O₁₀, M₃(PO₄)₂, M(PO₃)₂, M₂P₄O₁₂, and combinations thereof, where M represents a counterion having an oxidation state of +2. For example, M₂P₂O can include compounds such as Cu₂P₂O₇, Cu/MgP₂O₇, Cu/ZnP₂O₇, or any other suitable combination of counterions. The phosphates described herein are not limited to counterions having a +2 oxidation state. Other phosphate counterions can also be used to prepare other suitable near-infrared pigments.

Additional near-infrared pigments can include silicates. Silicates can have the same or similar counterions as phosphates. One non-limiting example can include M₂SiO₄, M₂Si₂O₆, and other silicates where M is a counterion having an oxidation state of +2. For example, the silicate M₂Si₂O₆ can include Mg₂Si₂O₆, Mg/CaSi₂O₆, MgCuSi₂O₆, Cu₂Si₂O₆, Cu/ZnSi₂O₆, or other suitable combination of counterions. The silicates described herein are not limited to counterions having a +2 oxidation state. Other silicate counterions can also be used to prepare other suitable near-infrared pigments.

An amount of radiation absorber in the fusing agent can vary depending on the type of radiation absorber. In some examples, the concentration of radiation absorber in the fusing agent can be from about 0.1 wt % to about 20 wt %. In one example, the concentration of radiation absorber in the fusing agent can be from about 0.1 wt % to about 20 wt %. In another example, the concentration can be from about 0.5 wt % to about 15 wt %. In yet another example, the concentration can be from about 1 wt % to about 10 wt %. In a particular example, the concentration can be from about 0.5 wt % to about 2 wt %. In one specific example, the fusing agent can include from about 60 wt % to about 94 wt % water, from about 5 wt % to about 35 wt % organic co-solvent, and from about 1 wt % to about 20 wt % radiation absorber, based on a total weight of the fusing agent.

A dispersant can be included in some examples. Dispersants can help disperse the radiation absorbers. In some examples, the dispersant itself can also absorb radiation. Non-limiting examples of dispersants that can be included as a radiation absorber, either alone or together with a pigment, can include polyoxyethylene glycol octylphenol ethers, ethoxylated aliphatic alcohols, carboxylic esters, polyethylene glycol ester, anhydrosorbitol ester, carboxylic amide, polyoxyethylene fatty acid amide, poly (ethylene glycol) p-isooctyl-phenyl ether, sodium polyacrylate, and combinations thereof.

Other Fluid Agents

In some examples, the three-dimensional printing kit, methods of three-dimensional printing, and/or three-dimensional printing system can include a detailing agent and/or the application thereof, or other fluid agents, such as coloring agents. A detailing agent can include a detailing compound capable of cooling the build material upon application. In some examples, the detailing agent can be printed around the edges of the portion of a build material that is or can be printed with the fusing agent. The detailing agent can increase selectivity between the fused and un-fused portions of the build material by reducing the temperature of the build material around the edge of the portion to be fused.

In some examples, the detailing agent can be a solvent that can evaporate at the temperature of the powder bed. As mentioned above, in some cases the build material in the powder bed can be preheated to a preheat temperature within 10° C. to 70° C. of the fusing temperature of the build material. Thus, the detailing agent can be a solvent that evaporates upon contact with the build material at the preheat temperature, thereby cooling the printed portion through evaporative cooling. In certain examples, the detailing agent can include water, co-solvents, or combinations thereof. In further examples, the detailing agent can be substantially devoid of radiation absorbers. That is, in some examples, the detailing agent can be substantially devoid of ingredients that absorb enough energy from the energy source to cause the build material to fuse. In certain examples, the detailing agent can include colorants such as dyes or pigments, but in small enough amounts such that the colorants do not cause the build material printed with the detailing agent to fuse when exposed to the energy source.

A coloring agent, on the other hand, can be included to add color to the printed three-dimensional object, and thus, can include a liquid vehicle and a colorant, e.g., dye(s) and/or pigments(s). The concentration of colorant in the coloring agent can be, for example, from about 0.5 wt % to about 10 wt %, from about 0.5 wt % to about 8 wt %, or from about 1 wt % to about 10 wt %. The liquid vehicle can include water, organic co-solvent, and in some instances surfactant and/or other additives.

### Definitions

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 10%, or, in one aspect within 5%, of a stated value or of a stated limit of a range. The term “about” when modifying a numerical range is also understood to include as one numerical subrange a range defined by the exact numerical value indicated, e.g., the range of about 1 wt % to about 5 wt % includes 1 wt % to 5 wt % as an explicitly supported sub-range.

As used herein, “kit” can be synonymous with and understood to include a plurality of multiple components where the different components can be separately contained (though in some instances co-packaged in separate containers) prior to use, but these components can be combined together during use, such as during the three-dimensional object build processes described herein. The containers can be any type of a vessel, box, or receptacle made of any material.

As used herein, “dispensing” when referring to fusing agent that may be used, for example, refers to any technology that can be used to put or place the fluid, e.g., fusing agent, on the build material or into a layer of build material for forming a green body object. For example, “applying” may refer to “jetting,” “ejecting,” “dropping,” “spraying,” or the like. In one example, applying may be by digitally ejecting or jetting the fusing agent selectively and iteratively onto the layers of build material.

As used herein, “jetting” or “ejecting” refers to fluid agents or other compositions that are expelled from ejection or jetting architecture, such as ink-jet architecture. Ink-jet architecture can include thermal or piezoelectric architecture. Additionally, such architecture can be configured to print varying drop sizes such as up to about 20 picoliters (pL), up to about 30 pL, or up to about 50 pL. Example ranges may include from about 2 pL to about 50 pL, or from about 3 pL to about 12 pL.

As used herein, a plurality of items, structural elements, compositional elements, and/or materials may be presented in a common list for convenience. However, these lists should be construed as though the individual member of the list is identified as a separate and unique member. Thus, no individual member of such list should be construed as a de facto equivalent of any other member of the same list based on presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, as well as to include all the individual numerical values or sub-ranges encompassed within that range as the individual numerical value and/or sub-range is explicitly recited. For example, a weight ratio range of about 1 wt % to about 20 wt % should be interpreted to include the explicitly recited limits of 1 wt % and 20 wt % and to include individual weights such as about 2 wt %, about 11 wt %, about 14 wt %, and sub-ranges such as about 10 wt % to about 20 wt %, about 5 wt % to about 15 wt %, etc.

### EXAMPLES

The following illustrates examples of the present disclosure. Numerous modifications and alternative compositions, methods, and systems may be devised without departing from the present disclosure. The appended claims are intended to cover such modifications and arrangements.

### Example 1—Preparation and Analysis of a Build Material

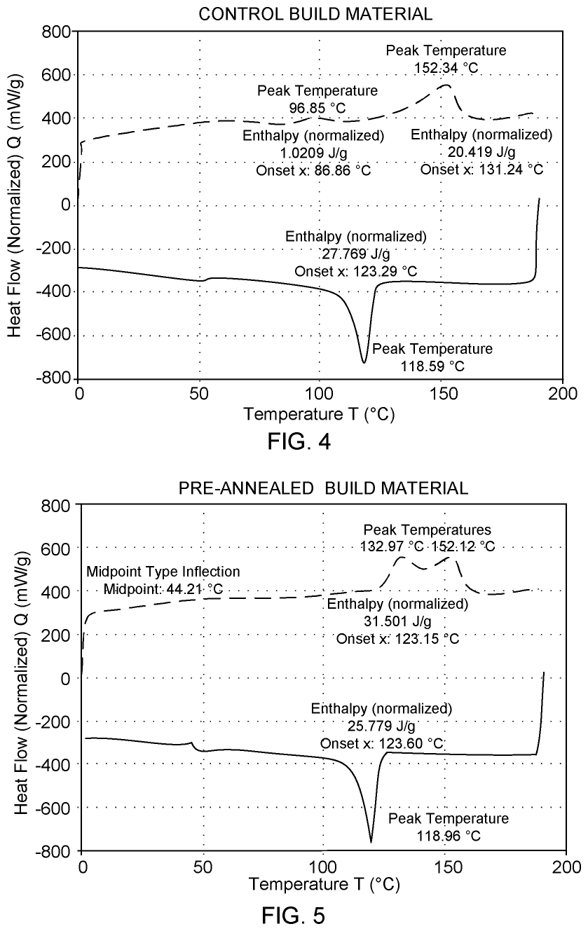

Commercially available polyether polyamide copolymer particles were obtained and separated into two portions. A first portion was annealed at a temperature of about 120° C. for about 20 hours and subsequently allowed to cool to room temperature (Annealed Build Material). A second portion was not annealed (hereinafter “Control Build Material”). Both portions were analyzed by differential scanning calorimetry (DSC) thermal analysis using a Discovery Series DSC 2500 calorimeter (commercially available from TA Instruments USA). The DSC analysis of the Control Build Material is illustrated in FIG. 4 and the DSC analysis of the Annealed Build Material is shown in FIG. 5. The data from both samples are illustrated by a dashed line, whereas the solid line represents the temperature heat flow pattern for the empty pan for comparison purposes. The Control Build Material exhibited on major peak temperature at 152.34° C. The DSC analysis of the Annealed Build Material, on the other hand, exhibited a bimodal melting peak at 132.97° C. and 152.12° C. The bimodal melting peak was not present in the Control Build Material. The bimodal melting peak indicates a structural or compositional change, and may indicate a change in the crystal structure of the annealed polyether polyamide copolymer particles. In either case, the composition of the annealed portion is verifiably different than the composition of the portion that was not annealed, and as illustrated below, this structural or compositional modification provided by annealing the build material lead to enhanced mechanical properties which were measurable.

### Example 2—Printing Three-Dimensional Objects

Several three-dimensional printed objects were prepared in the shape of dumbbells (or “dog bones”) using a fusing agent and common set of printing conditions. The dumbbells were formed with an elongated middle section flanked by two end sections that were formed having a larger size so that the middle section was the structurally weakest section. Type S1 dumbbells were prepared and tested in accordance with DIN 53504:2009-10. This structure is a good shape for testing mechanical properties, such as tensile strength, elongation at break, etc.

To carry out the study, a series of print jobs were performed to obtain Type S1 dumbbells using the Control Build Material and the Annealed Build Material, both without any filler so that the material itself could be compared. The Annealed Build Material was prepared as described in Example 1. In more specific detail, the three-dimensional printed objects were printed using multi-jet fusion (MJF) printers with the same fusing agent, which was iteratively jetted layer-by-layer on either the control build material or the annealed build material. Upon printing an individual layer in the respective build materials, the same electromagnetic energy source was used to selectively form multiple fused layers, resulting in the two different types of three-dimensional printed objects (from Control Build Material and from Annealed Build Material).

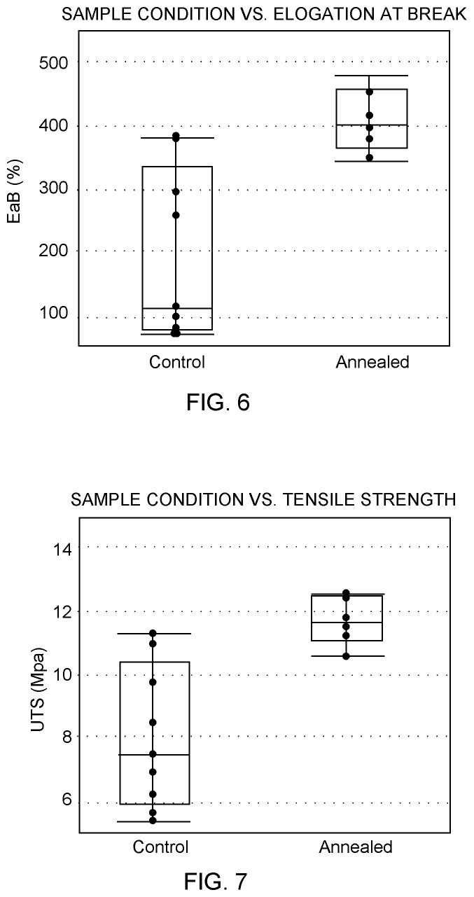

After printing, mechanical properties were analyzed. The various dumbbell samples were evaluated for elongation at breaking point, which is measured as a percentage, as well as for ultimate tensile strength (UTS), measured in megapascals (MPa). The testing was performed by gripping the end sections of the dumbbell objects and providing stress in relation to the pulling apart of the two ends and stretching the middle portion (pulling force applied by an INSTRON™ Tensiometer with a pull rate of 500 mm per minute). The resulting data was averaged based on all of the dumbbell samples tested, which were prepared from either the Control or the Annealed Build Material. The mechanical properties data collected for the dumbbells is provided in FIGS. 6 and 7. As can be seen, the elongation at breaking point was increased (FIG. 6) as well as the ultimate tensile strength (FIG. 7), with the only difference in processing being the inclusion of annealing, e.g., no other differences as to materials, temperatures, properties, etc. were implemented.

What is claimed is:

1. A three-dimensional printing kit comprising:
a fusing agent including water and a radiation absorber; and
a build material including from about 95 wt % to 100 wt % of annealed polyether polyamide copolymer particles having a D50 particle size from about 2 μm to about 150 μm.

2. The three-dimensional printing kit of claim 1, wherein the annealed polyether polyamide copolymer is a block copolymer including a polyether block and a polyamide block.

3. The three-dimensional printing kit of claim 2, wherein the polyether block includes polypropylene oxide, polyethylene oxide, polytetramethylene oxide, polyethylene oxide-b-propylene oxide, or a combination thereof.

4. The three-dimensional printing kit of claim 2, wherein the polyamide block includes polyamide-6, polyamide-9, polyamide-11, polyamide-12, polyamide-66, polyamide-612, thermoplastic polyamide, or a combination thereof.

5. The three-dimensional printing kit of claim 1, wherein the annealed polyether polyamide copolymer particles exhibit multimodal melting peaks adjacent to one another that are not present prior to annealing.

6. The three-dimensional printing kit of claim 1, wherein the build material is devoid of polymer other than the annealed polyether polyamide copolymer.

7. The three-dimensional printing kit of claim 1, further comprising a detailing agent comprising a detailing compound, wherein the detailing compound reduces a temperature of the bed material onto which the detailing agent is applied.

8. A method of three-dimensional printing comprising:
iteratively applying individual build material layers of a build material including from about 95 wt % to 100 wt % of annealed polyether polyamide copolymer particles having a D50 particle size ranging from about 2 μm to about 150 μm;
based on a 3D object model, iteratively and selectively dispensing a fusing agent onto individual build material layers, wherein the fusing agent comprises water and a radiation absorber; and
iteratively exposing a powder bed to energy to selectively fuse the annealed polyether polyamide copolymer particles in contact with the radiation absorber and form a fused polymer matrix at the individual build material layers resulting in a fused three-dimensional object.

9. The method of claim 8, further comprising preliminarily annealing a polyether polyamide copolymer build material at a temperature within 50° C. below a melt peak temperature of the polyether polyamide copolymer for a time period ranging from 15 minutes to 48 hours to form the annealed polyether polyamide copolymer particles.

10. The method of claim 8, wherein the annealed polyether polyamide copolymer is a block copolymer with a polyether block and a polyamide block, wherein the polyether block includes polypropylene oxide, polyethylene oxide, polytetramethylene oxide, polyethylene oxide-b-propylene oxide, or a combination thereof.

11. The method of claim 8, wherein the annealed polyether polyamide copolymer is a block copolymer with a polyether block and a polyamide block, wherein the polyamide block includes polyamide-6, polyamide-9, polyamide-11, polyamide-12, polyamide-66, polyamide-612, thermoplastic polyamide, or a combination thereof.

12. The method of claim 8, wherein the fused three-dimensional object has a tensile strength that is about 1.2 to about 4 times greater than a comparative three-dimensional object formed from polyether polyamide copolymer particles that are not annealed but otherwise have the same D50 particle size, molecular weight, and ratio of polyether to polyamide content.

13. The method of claim 8, wherein the build material is devoid of polymer other than the annealed polyether polyamide copolymer.

14. A three-dimensional printing system, comprising:
a build material including from about 95 wt % to 100 wt % of annealed polyether polyamide copolymer particles having a D50 particle size from about 2 μm to about 150 μm;
a fusing agent including water and a radiation absorber;
a printhead fluidly coupled to or fluidly coupleable to the fusing agent to selectively and iteratively eject the fusing agent onto successive placed individual layers of the build material; and
a radiant energy source positioned to expose the individual layers of the build material to radiation energy to selectively fuse the annealed polyether polyamide copolymer particles in contact with the radiation absorber to iteratively form a three-dimensional object.

15. The three-dimensional printing system of claim 14, wherein the annealed polyether polyamide copolymer is a block copolymer with a polyether block and a polyamide block, wherein the polyether block includes polypropylene oxide, polyethylene oxide, polytetramethylene oxide, polyethylene oxide-b-propylene oxide, or a combination thereof, and wherein the polyamide block includes polyamide-6, polyamide-9, polyamide-11, polyamide-12, polyamide-66, polyamide-612, thermoplastic polyamide, or a combination thereof.
